(19) United States
(12) Patent Application Publication
(10) Pub. No.: US 2025/0323985 A1
(43) Pub. Date: Oct. 16, 2025

(54) METHOD FOR SHARING DATA NETWORK AND ELECTRONIC DEVICE

(71) Applicant: GUANGDONG OPPO MOBILE TELECOMMUNICATIONS CORP., LTD, Dongguan, Guangdong (CN)

(72) Inventor: Yifan ZHANG, Dongguan, Guangdong (CN)

(73) Assignee: GUANGDONG OPPO MOBILE TELECOMMUNICATIONS CORP., LTD, Dongguan, Guangdong (CN)

(21) Appl. No.: 18/878,539

(22) PCT Filed: May 5, 2022
(86) PCT No.: PCT/CN2022/090996

§ 371 Date: Dec. 23, 2024

(30) Foreign Application Priority Data
Jun. 10, 2021 (CN) 202110647008.7

(51) Int. Cl. H04L 69/08; H04W 80/12

(52) U.S. Cl. CPC H04L 69/08; H04W 80/12

(57) ABSTRACT

A method for sharing a data network and an electronic device are provided. The method includes: converting a first data packet satisfied with a first protocol format and sent by a first virtual network card into the first data packet satisfied with a second protocol format based on a preset application-layer protocol; sending the first data packet satisfied with the second protocol format to a second terminal through a Bluetooth network, and receiving a second data packet satisfied with the second protocol format and returned by the second terminal; and converting the second data packet satisfied with the second protocol format into the second data packet satisfied with the first protocol format, and transmitting the second data packet satisfied with the first protocol format to the first virtual network card, based on the preset application-layer protocol.

### CROSS REFERENCE TO RELATED APPLICATIONS

The present disclosure is a 35 U.S.C. § 371 National Phase conversion of International Patent Application No. PCT/CN2022/090996, filed May 5, 2022, which claims priority to Chinese Patent Applicant No. 202110647008.7, filed Jun. 10, 2021, and the contents of both of which are incorporated herein by their entireties.

### TECHNICAL FIELD

The present disclosure relates to the field of communication technologies, and in particular to a method for sharing a data network and an electronic device.

### BACKGROUND

In the related art, a terminal may perform a Bluetooth connection to a wearable device, and the terminal and the wearable device may transmit data to each other through a network layer, such that the terminal and the wearable device may share data network with each other. In a method for implement the network sharing based on the network layer, there is a problem of poor device compatibility, which cannot be widely applied to all kinds of terminals.

### SUMMARY OF THE PRESENT DISCLOSURE

According to a first aspect, some embodiments of the present disclosure provide a method for sharing a data network, applicable to a first terminal. The method includes: converting a first data packet satisfied with a first protocol format and sent by a first virtual network card into the first data packet satisfied with a second protocol format based on a preset application-layer protocol; sending the first data packet satisfied with the second protocol format to a second terminal through a Bluetooth network, and receiving a second data packet satisfied with the second protocol format and returned by the second terminal, wherein the second data packet is configured to represent a response for the first data packet returned by a corresponding server; and converting the second data packet satisfied with the second protocol format into the second data packet satisfied with the first protocol format, and transmitting the second data packet satisfied with the first protocol format to the first virtual network card, based on the preset application-layer protocol. The first protocol format is configured to represent an internet protocol (IP), and the second protocol format is configured to represent a transmission control protocol (TCP) and/or a user datagram protocol (UDP).

According to a second aspect, some embodiments of the present disclosure provide a method for sharing a data network, applicable to a second terminal. The method includes: receiving a first data packet satisfied with a second protocol format and sent by a first terminal through a Bluetooth network, and obtaining a second data packet satisfied with a first protocol format and returned by a server based on a first data packet satisfied with the second protocol format, wherein the second data packet is configured to represent a response for the first data packet returned by a corresponding server; converting the second data packet satisfied with the first protocol format into the second data packet satisfied with the second protocol format based on a preset application-layer protocol; and sending the second data packet satisfied with the second protocol format to the first terminal through the Bluetooth network. The first protocol format is configured to represent an IP, and the second protocol format is configured to represent a TCP and/or a UDP.

According to a third aspect, some embodiments of the present disclosure further provide an electronic device. The electronic device includes a processor and a memory. The memory is configured to store a computer program capable of being run on the processor. The processor is configured to, when running the computer program, perform: converting a first data packet satisfied with a first protocol format and sent by a first virtual network card into the first data packet satisfied with a second protocol format based on a preset application-layer protocol; sending the first data packet satisfied with the second protocol format to a second terminal through a Bluetooth network, and receiving a second data packet satisfied with the second protocol format and returned by the second terminal, wherein the second data packet is configured to represent a response for the first data packet returned by a corresponding server; and converting the second data packet satisfied with the second protocol format into the second data packet satisfied with the first protocol format, and transmitting the second data packet satisfied with the first protocol format to the first virtual network card, based on the preset application-layer protocol. Alternatively, the processor is configured to, when running the computer program, perform: receiving a first data packet satisfied with a second protocol format and sent by a first terminal through a Bluetooth network, and obtaining a second data packet satisfied with a first protocol format and returned by a server based on a first data packet satisfied with the second protocol format, wherein the second data packet is configured to represent a response for the first data packet returned by a corresponding server; converting the second data packet satisfied with the first protocol format into the second data packet satisfied with the second protocol format based on a preset application-layer protocol; and sending the second data packet satisfied with the second protocol format to the first terminal through the Bluetooth network. The first protocol format is configured to represent an IP, and the second protocol format is configured to represent a TCP and/or a UDP.

### BRIEF DESCRIPTION OF THE DRAWINGS

FIG. 1 is a flowchart of an implementation of a method for sharing a data network according to an embodiment of the present disclosure.

FIG. 2 is a flowchart of performing data conversion on a first terminal according to an embodiment of the present disclosure.

FIG. 3 is a flowchart of an implementation of a method for sharing a data network according to an embodiment of the present disclosure.

FIG. 4 is a schematic diagram of performing data network sharing on the first terminal in a working mode according to an embodiment of the present disclosure.

FIG. 5 is a block diagram of a network hardware of the first terminal configured with a plurality of processors according to an embodiment of the present disclosure.

FIG. 6 is a schematic diagram of performing transmission of a data packet on the first terminal configured with a plurality of processors according to an embodiment of the present disclosure.

FIG. 7 is a flowchart of an implementation of a method for sharing a data network according to an embodiment of the present disclosure.

FIG. 8 is a flowchart of an implementation of a method for sharing a data network according to another embodiment of the present disclosure.

FIG. 9 is a flowchart of performing data conversion on a second terminal according to an embodiment of the present disclosure.

FIG. 10 is a structural schematic diagram of an apparatus for sharing a data network according to an embodiment of the present disclosure.

FIG. 11 is a structural schematic diagram of an apparatus for sharing a data network according to another embodiment of the present disclosure.

FIG. 12 is a structural schematic diagram of a hardware composition structure of an electronic device according to an embodiment of the present disclosure.

### DETAILED DESCRIPTION

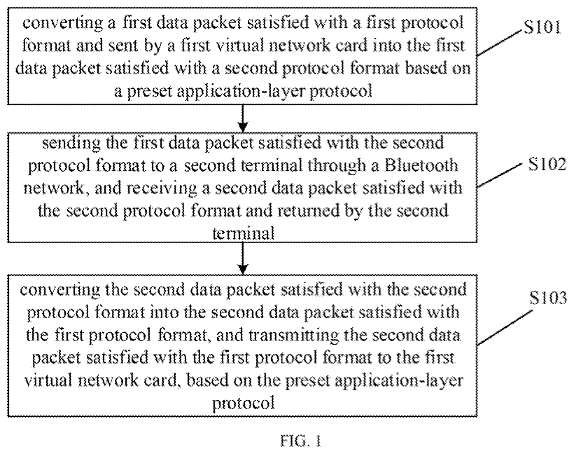

Some embodiments of the present disclosure provide a method for sharing a data network. FIG. 1 is a flowchart of an implementation of a method for sharing a data network according to an embodiment of the present disclosure. As shown in FIG. 1, the method for sharing the data network is applicable to/performed by a first terminal and includes the following operations.

At block S101, based on a preset application-layer protocol, a first data packet satisfied with a first protocol format and sent by a first virtual network card is converted into the first data packet satisfied with a second protocol format.

During the process of transmitting data, application data of an application program of the first terminal may follow a certain protocol format. In the embodiments of the present disclosure, based on the preset application-layer protocol, the first data packet satisfied with the first protocol format and sent by the first virtual network card is converted into the first data packet satisfied with the second protocol format. The first protocol format is configured to represent an internet protocol (IP), and the second protocol format is configured to represent a transmission control protocol (TCP) and/or a user datagram protocol (UDP). In this way, the first data packet satisfied with an IP format may be converted into the first data packet satisfied with a TCP and/or the first data packet satisfied with a UDP format. The first data packet satisfied with the second protocol format is application layer data, such that the application data of the first terminal may be transmitted on an application layer.

In an actual application, the first data packet satisfied with the first protocol format is generated by the conversion of application data satisfied with the TCP format/satisfied with the UDP format into application data satisfied with the IP format. The first terminal may be a smart watch. When the first terminal is in a state without a network, for example, in a condition where both a cellular network function and a wireless network connection of the first terminal are in an off state, the first terminal and a second terminal may be paired with each other through the second terminal with a network access capability, such that the first terminal and the second terminal may share the data network with each other.

In an actual application, the preset application-layer protocol may be a light weight IP (LwIP), such that it may be possible to maintain a main function of the TCP and reduce an occupation on a random access memory (RAM) of the terminal, thereby saving a resource and power consumption of the terminal. The preset application-layer protocol may be encapsulated based on a Bluetooth low energy generic attribute (BLE GATT) profile or a Bluetooth serial port profile (BT SPP).

At block S102, the first data packet satisfied with the second protocol format is sent to the second terminal through a Bluetooth network, and the second data packet satisfied with the second protocol format and returned by the second terminal is received. The second data packet is configured to represent a response for the first data packet returned by a corresponding server.

The first terminal may perform a Bluetooth pairing connection to the second terminal. The first data packet satisfied with the second protocol format is send to the second terminal through the Bluetooth network, and the second data packet satisfied with the second protocol format and returned by the second terminal is received. The second data packet is configured to represent the response for the first data packet returned by the corresponding server. In this way, the first terminal may be capable of obtaining the response for the first data packet from the network through the second terminal, such that the first terminal may be capable of sharing the data network based on the second terminal.

In an actual application, when the first terminal and the second terminal may transmit a data packet satisfied with the first protocol format to each other by using a standard Bluetooth personal area network (BT-PAN) Bluetooth protocol, it is necessary to acquire a certain permission. In some embodiments, the first terminal needs to acquire a permission to access internet, and the second terminal needs to enable a permission to share the network via Bluetooth, such that the first terminal and the second terminal may successfully transmit the data packet satisfied with the first protocol format to each other. Moreover, when the standard BT-PAN Bluetooth protocol is not supported by the first terminal or the second terminal, the first terminal and the second terminal cannot share the network with each other based on the Bluetooth, and thus the second terminal and the first terminal cannot transmit data to each other. In the embodiments of the present disclosure, the data packet transmitted between the first terminal and the second terminal is satisfied with the second protocol format. That is, the data is transmitted on the application layer, rather than directly transmitting an underlying data packet, such that it is not necessary to obtain a user permission of the first terminal and a user permission of the second terminal. Therefore, even on a terminal which does not support the standard BT-PAN Bluetooth protocol, the Bluetooth network sharing may be implemented, such that different terminals may share the network with each other, thereby improving compatibility of the network sharing.

At block S103, based on the application-layer protocol, the second data packet satisfied with the second protocol format is converted into the second data packet satisfied with the first protocol format, and the second data packet satisfied with the first protocol format is transmitted to the first virtual network card. The first protocol format is configured to represent the IP, and the second protocol format is configured to represent the TCP and/or the UDP.

After receiving the second data packet satisfied with the second protocol format, the first terminal needs to perform format conversion on the second data packet satisfied with the second protocol format. Based on the application-layer protocol, the second data packet satisfied with the second protocol format may be converted into the second data packet satisfied with the first protocol format, and the second data packet satisfied with the first protocol format may be transmitted to the first virtual network card.

In an actual application, after the second data satisfied with the first protocol format is received by the first virtual network card, the second data satisfied with the first protocol format is converted into a second data application satisfied with the second protocol format through a network protocol stack of a kernel. In this way, the second data may be returned to the application layer, so as to enable the application program to obtain corresponding response data from the network.

As shown in FIG. 2, FIG. 2 is a flowchart of performing data conversion on a first terminal according to an embodiment of the present disclosure. The application data of the application program belongs to application-layer data. When the application-layer data needs to be transmitted to other layers, the application-layer data needs to be transmitted through a data interface. In the embodiments of the present disclosure, the application data satisfied with the second protocol format of the application program is sent to the kernel through an intermediate software abstraction layer. The intermediate software abstraction layer may be a socket. According to the TCP/the IP, the application data satisfied with the second protocol format of the kernel is converted into the first data packet satisfied with the first protocol format, such that the application data may be converted into the application data which may be transmitted over/on the internet. The first data satisfied with the first protocol format is sent to the first virtual network card, such that the first data satisfied with the first protocol format may be transmitted from the application layer to a network proxy layer. The first virtual network card may be configured to simulate network environment and a network adapter. In an actual application, when the first terminal is configured with a physical network card, the first terminal may be directly connected to the network through the physical network card. When the first terminal is configured with a virtual network card, the data network may be shared by connecting the virtual network to the second terminal, and the first virtual network card may be capable of building the network environment according to the data network sharing provided by the second terminal. The first data packet satisfied with the first protocol format is sent to the application layer by the network proxy layer, the first data packet satisfied with the first protocol format is converted into the first data packet satisfied with the second protocol format based on the preset application-layer protocol, and the preset application-layer protocol may be the LwIP. In this way, the data sent from the first terminal to the second terminal is the application-layer data, and the application data interaction/transmission may be performed between two different terminals without the need to acquire an additional network permission, thereby expanding an application scope of the data network sharing.

In addition, the first terminal may further receive the second data packet, which is satisfied with the second protocol format and is returned by the second terminal, through the Bluetooth network. In the network proxy layer, based on the application-layer protocol, the second data packet satisfied with the second protocol format is converted into the second data packet satisfied with the first protocol format, and the second data packet satisfied with the first protocol format is returned to the first virtual network card. The second data packet satisfied with the first protocol format is returned to the kernel by the first virtual network card. According to the TCP/the IP, the second data packet satisfied with the first protocol format is converted into TCP application data/UDP application data and is returned to the application layer, and the data transmission between the first terminal and the second terminal is finished/terminated.

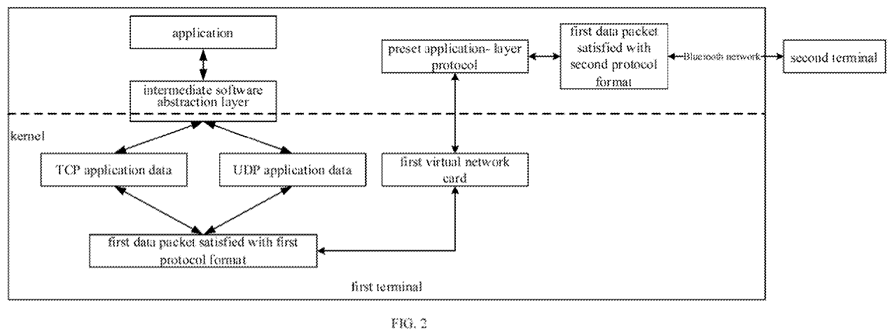

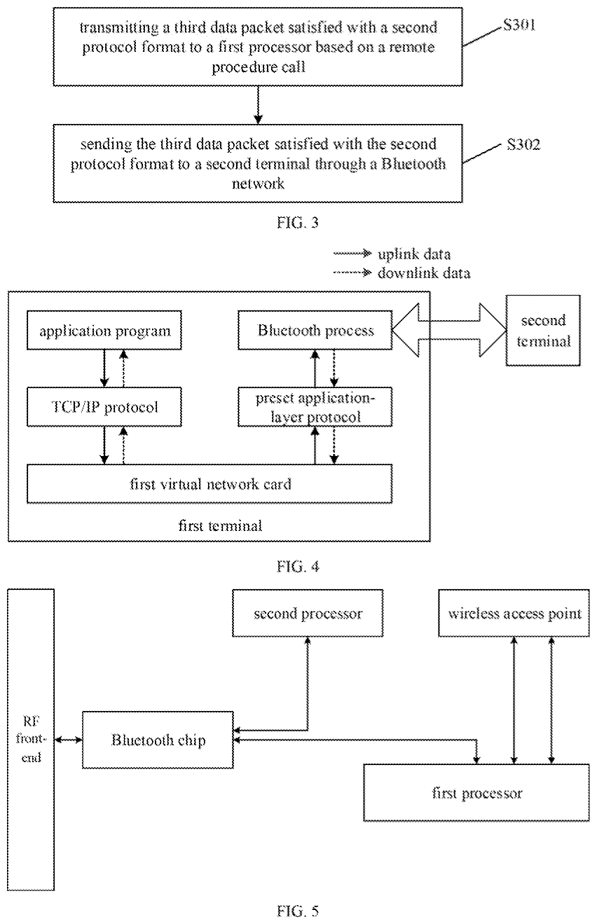

In an embodiment, as shown in FIG. 3, the first terminal is configured with at least two processors. A Bluetooth chip of the first terminal is mounted on a first processor. The method further includes the following operations.

At block S301, a third data packet satisfied with the second protocol format is transmitted to the first processor based on a remote procedure call. The third data packet satisfied with the second protocol format is generated by the conversion of the second virtual network card, running by a second processor, based on the preset application-layer protocol.

The first terminal may be configured with different numbers of processors to meet different needs. When the first terminal includes a processor, the Bluetooth chip of the first terminal is mounted on the first processor, and the first virtual network card is run by the first processor. That is, the first processor of the first terminal is responsible for processing the first data packet and the second data packet. As shown in FIG. 4, FIG. 4 is a schematic diagram of performing data network sharing on the first terminal in a working mode according to an embodiment of the present disclosure. As shown in FIG. 4, data output by the first virtual network card is the first data packet satisfied with the first protocol format. After the first data packet satisfied with the first protocol format is converted into the first data packet satisfied with the second protocol format through the preset application-layer protocol, the first data packet satisfied with the second protocol format is sent to the second terminal through a Bluetooth connection.

When the first terminal is configured with the at least two processors, it indicates that the first terminal may currently support a plurality of different working modes in an actual application. The Bluetooth chip of the first terminal is mounted on the first processor, so as to enable the first terminal to use the Bluetooth connection in the plurality of different working modes. Therefore, there is no need to equip each of the at least two processors with a Bluetooth chip, so as to save power consumption of the first terminal. As shown in FIG. 5, FIG. 5 is a block diagram of a network hardware of the first terminal configured with a plurality of processors according to an embodiment of the present disclosure. When a processor currently running on the first terminal is the second processor, the third data packet, which is satisfied with the first protocol format and is sent by the second virtual network card of the second processor, is converted into the third data packet satisfied with the second protocol format based on the preset application-layer protocol. The third data packet is the application data during a process of operating/running the application. Since the Bluetooth chip of the first terminal is mounted on the first processor, it is necessary to transmit data on the second processor to the first processor through the remote procedure call when the data on the second processor is transmitted by means of Bluetooth, and the data on the second processor is sent through the Bluetooth chip mounted on the first processor.

At block S302, the third data packet satisfied with the second protocol format is sent to the second terminal through the Bluetooth network.

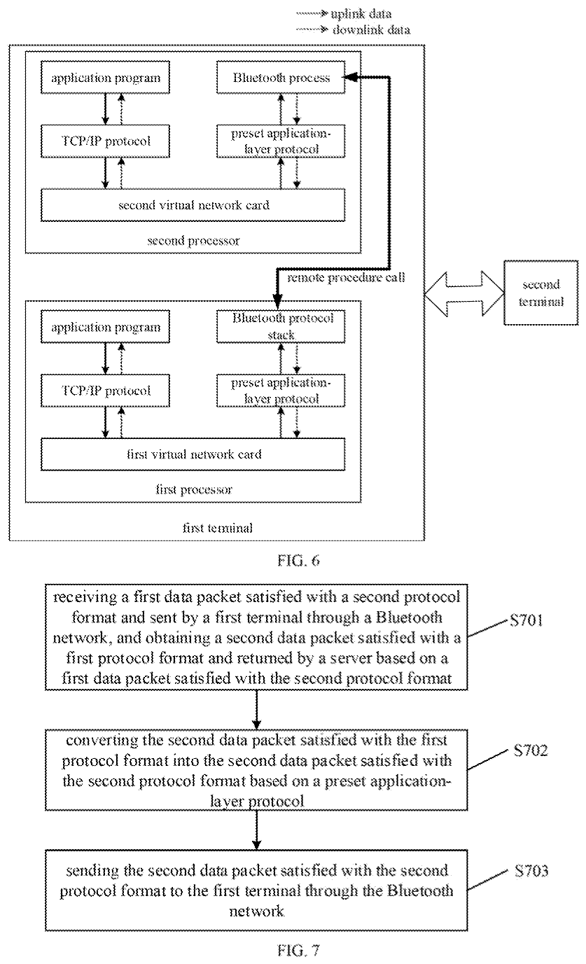

After the third data packet satisfied with the second protocol format is obtained by the first processor, the third data packet satisfied with the second protocol format is sent to the second terminal through the Bluetooth chip mounted on the first processor, such that the data interaction/transmission may be performed between the second terminal and the second processor of the first terminal. Therefore, it may be possible to enable to the first terminal to use the network function of the second terminal to obtain the network data required by the second processor. In an actual application, when response data for the third data packet, which is returned by the second terminal, is received by the Bluetooth chip of the first terminal, the response data for the third data packet may be transmitted to the second processor through the remote procedure call, such that the second processor may receive corresponding network data and perform subsequent data processing. As shown in FIG. 6, FIG. 6 is a schematic diagram of performing transmission of a data packet on the first terminal configured with a plurality of processors according to an embodiment of the present disclosure, that is, the first terminal is configured with the plurality of processors, so as to ensure that the data network sharing may be implemented when different processors run on the first terminal.

In an embodiment, operating power consumption of the first processor is lower than the operating power consumption of the second processor.

In some embodiments, when the first terminal is configured with the at least two processors. the operating power consumption of the first processor is lower than the operating power consumption of the second processor, such that the Bluetooth chip may be mounted on the first processor, which bas lower operating power consumption among the plurality of processors. In an actual application, each of the at least two processors of the first terminal may operate under different voltages and different frequencies, a computationally intensive task may be assigned to a corresponding one of the at least two processors, which operates at a high frequency, for processing. A less demanding task may be assigned to a corresponding one of the at least two processors, which operates at a low frequency, for processing. In this way, different tasks may be assigned to different processors for processing, so as to reduce the power consumption of the first terminal. In some embodiments, for the smart watch configured with two processors, there are two working modes. In a first working mode, the smart watch may perform a conventional task to improve the battery life of the smart watch. When the smart watch is in the first working mode, a required frequency parameter may not be too high due to a simple task, and a corresponding processor running on the first terminal is the first processor with low power consumption. When the smart watch is in a second working mode, a complex process, such as a scenario of online map navigation, may be performed. A corresponding processor running on the first terminal is the second processor with high power consumption. The Bluetooth chip is mounted on the first processor, so as to enable the first processor and the second processor to share a same Bluetooth chip, thereby saving the power consumption.

In the above embodiments, the data packet is converted into a data packet satisfied with a corresponding protocol format through the preset application-layer protocol, and the interaction/transmission of the data packet is performed on the application layer through the Bluetooth network. Therefore, the data network sharing may be performed between different terminals (i.e., the different terminals may share the data network with each other) when it is not necessary to acquire an underlying permission of the terminal, such that the compatibility of the data network sharing may be improved.

Some embodiments of the present disclosure further provide a method for sharing a data network. As shown in FIG. 7, the method for sharing the data network is applicable to/performed by the second terminal and includes the following operations.

At block S701, a first data packet, which is satisfied with the second protocol format and is sent by the first terminal, is received through the Bluetooth network, and the second data packet, which is satisfied with the first protocol format and is returned by a server, is obtained based on the first data packet satisfied with the second protocol format. The second data packet is configured to represent a response for the first data packet returned by a corresponding server.

The first data packet, which is satisfied with the second protocol format and is sent by the first terminal, is received by the second terminal through the Bluetooth network. The second terminal obtains the second data packet satisfied with the first protocol format from the server based on the first data packet satisfied with the second protocol format. The second data packet is configured to represent the response for the first data packet returned by the corresponding server. In an actual application, the intermediate software abstraction layer may be capable of sending the first data packet satisfied with the second protocol format to a kernel of the second terminal. The kernel converts the first data packet satisfied with the second protocol format into the first data packet satisfied with the first protocol format, and sends the first data packet satisfied with the first protocol format to the server through the physical network card, so as to obtain the second data packet satisfied with the first protocol format. The second data packet is obtained by means of accessing the network through the physical network card of the second terminal, such that the first terminal may indirectly share the data network through the second terminal, and obtain corresponding data.

At block S702, based on the preset application-layer protocol, the second data packet satisfied with the first protocol format is converted into the second data packet satisfied with the second protocol format.

The first terminal and the second terminal may transmit the data to each other based on the application layer. Therefore, after the second data packet. which is satisfied with the first protocol format and is returned by the server, is received, the second data packet satisfied with the first protocol format is converted into the second data packet satisfied with the second protocol format based on the preset application-layer protocol, such that the data may be transmitted based on the data packet satisfied with the TCP format and/or the UDP format. In an actual application, the preset application-layer protocol may be encapsulated based on a BLE GATT profile or a BT SPP. In an actual application, according to the preset application-layer protocol, the second data satisfied with the first protocol format and obtained from the server may be converted into the second data satisfied with the second protocol format by the kernel.

At block S703, the second data packet satisfied with the second protocol format is sent to the first terminal through the Bluetooth network. The first protocol format is configured to represent the IP. The second protocol format is configured to represent the TCP and/or the UDP.

The first terminal may perform the Bluetooth pairing connection to the second terminal. The first data packet satisfied with the second protocol format is send to the second terminal through the Bluetooth network, such that different terminals may transmit the data to each other based on the application layer. In an actual application, when the first terminal and the second terminal may transmit the data packet satisfied with the first protocol format to each other by using the standard BT-PAN Bluetooth protocol, the first terminal and the second terminal need to acquire a certain network permission to transmit the data packet satisfied with the first protocol format due to a case that the data packet satisfied with the first protocol format, such as the first data packet satisfied with the first protocol format, is a data packet transmitted over the internet. In some embodiments, the first terminal needs to acquire a permission to access internet, and the second terminal needs to enable a permission to share the network via Bluetooth, such that the first terminal and the second terminal may successfully transmit the data packet satisfied with the first protocol to each other after each of the first terminal and the second terminal acquires a corresponding network permission. When the standard BT-PAN Bluetooth protocol is not supported by the first terminal or the second terminal, that is, the network sharing cannot be performed via the Bluetooth, the corresponding network permission cannot be acquired by the first terminal or the second terminal, and thus the data transmission cannot be performed based on the Bluetooth network sharing. In the embodiments of the present disclosure, since the second data packet transmitted between the first terminal and the second terminal is satisfied with the second protocol format, rather than the second data packet transmitted satisfied with the first protocol format, it is not necessary for the first terminal and the second terminal to acquire the certain network permission to share the network. In addition, the second data packet satisfied with the second protocol format is the response for the first data packet, which is sent by the first terminal and obtained from the network. Therefore, the process of performing the data interaction between the first data packet and the second data packet essentially implements the network sharing of the first terminal based on the Bluetooth connection of the second terminal, such that the different terminals may share the data network with each other, thereby improving the compatibility of the network sharing.

In an embodiment, Bluetooth networks of the first terminal and the second terminal are paired with each other based on a first preset application.

The Bluetooth networks of the first terminal and the second terminal are paired with each other based on the first preset application, such that the different terminals may share the data network with each other. In some embodiments, the first preset application is installed on the second terminal, and the first terminal and the second terminal may be paired with each other through the first preset application, such that the first terminal and the second terminal may be paired with each other based on the first preset application. In an actual application, the first preset application may be configured for network agent, and the first preset application may be responsible for processing the first data packet satisfied with the second protocol format and received by the second terminal and the second data packet satisfied with the second protocol format. In some embodiments, the first preset application may be capable of sending the obtained second data packet satisfied with the second protocol format to the Bluetooth chip of the second terminal, and the second data packet satisfied with the second protocol format is sent to the first terminal through the Bluetooth network, such that the different terminals may share the data network with each other through the first preset application.

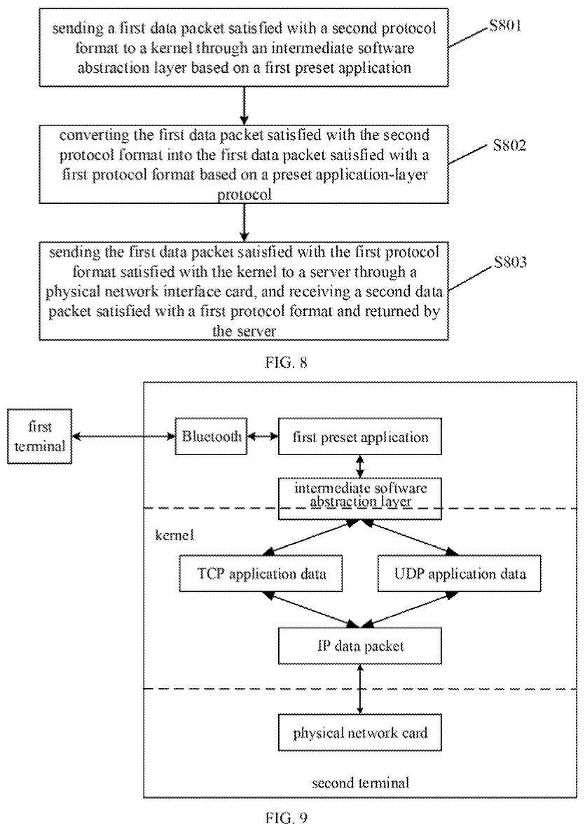

In an embodiment, as shown in FIG. 8, an operation of obtaining the second data packet satisfied with the first protocol format and returned by the server based on the first data packet satisfied with the second protocol format, includes the following operations.

At block S801, based on the first preset application, the first data packet satisfied with the second protocol format is sent to the kernel through the intermediate software abstraction layer.

For the first data packet satisfied with the second protocol format and received by the second terminal, the first preset application may send the first data packet satisfied with the second protocol format to the kernel through the intermediate software abstraction layer. In an actual application, the intermediate software abstraction layer may be a socket, such that the first data packet satisfied with the second protocol format may be obtained by the kernel.

At block S802, based on the application-layer protocol, the first data packet satisfied with the second protocol format may be converted into the first data packet satisfied with the first protocol format.

In the kernel, the first data packet satisfied with the second protocol format may be converted into the first data packet satisfied with the first protocol format based on the preset application-layer protocol. The converted first data satisfied with the first protocol format may be transmitted over the internet.

At block S803, the first data packet satisfied with the first protocol format in the kernel is sent to the server through the physical network card, and the second data packet, which is satisfied with the first protocol format and is returned by the server, may be received.

The kernel sends the first data packet satisfied with the first protocol format to the server through the physical network card of the second terminal. Since the first data satisfied with the first protocol format may be transmitted over the internet, and the physical network card of the second terminal may enable the second terminal to have the network access capability, the second terminal may obtain the second data packet returned by the server on the internet according to the first data satisfied with the first protocol format. As shown in FIG. 9, FIG. 9 is a flowchart of performing data conversion on a second terminal according to an embodiment of the present disclosure. During a process of converting the data packet of the second terminal, data sent by the first terminal may be considered as the application data of the first preset application, and the second terminal may send the application data of the first preset application to the first terminal. That is, it may be considered that the application data of the first preset application may be transmitted between the first terminal and the second terminal to perform the data interaction, and the transmitted data may be the application data. Therefore, when it is not necessary for both of the first terminal and the second terminal to acquire the certain network permission, the data packet may also be successfully transmitted. In addition, in a condition of installing the first preset application, the two terminals may share the data network with each other, thereby expanding the application scope of the data network sharing.

In the above embodiments, the first data packet satisfied with the second protocol format and sent by the first terminal is received through the Bluetooth network, and the first data packet satisfied with the second protocol format is converted into the first data packet satisfied with the first protocol format. In this way, the response information of the first data packet may be obtained from the network according to the physical network card of the second terminal, and the second data packet may be returned to the first terminal, such that the first terminal may perform the data network sharing through the network card of the second terminal.

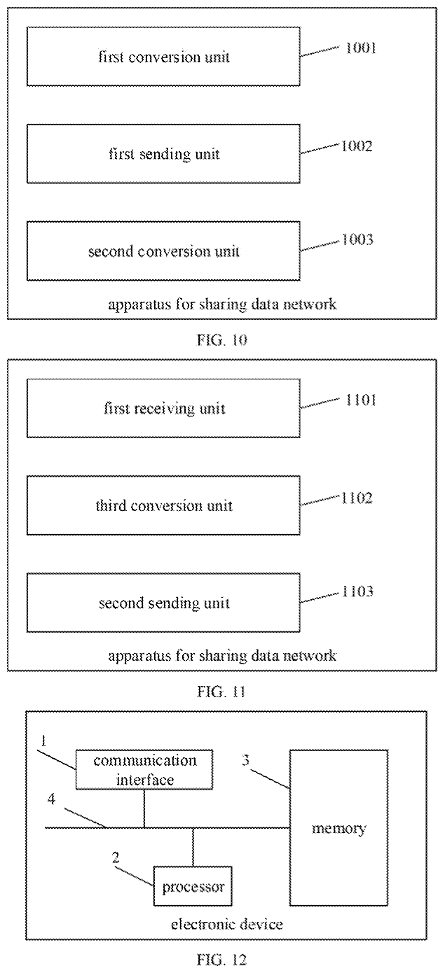

In order to perform the method provided by the embodiments of the present disclosure, some embodiments of the present disclosure further provide an apparatus for sharing a data network, as shown in FIG. 10, the apparatus includes a first conversion unit 1001, a first sending unit 1002, and a second conversion unit 1003.

The first conversion unit 1001 is configured to convert a first data packet satisfied with a first protocol format and sent by a first virtual network card into the first data packet satisfied with the second protocol format based on a preset application-layer protocol.

The first sending unit 1002 is configured to send the first data packet satisfied with the second protocol format to a second terminal through a Bluetooth network, and receive a second data packet satisfied with the second protocol format and returned by the second terminal. The second data packet is configured to represent a response for the first data packet returned by a corresponding server.

The second conversion unit 1003 is configured to convert the second data packet satisfied with the second protocol format into the second data packet satisfied with the first protocol format and transmit the second data packet satisfied with the first protocol format to the first virtual network card, based on the preset application-layer protocol. The first protocol format is configured to represent an IP, and the second protocol format is configured to represent a TCP and/or a UDP.

In an embodiment, the first terminal is configured with at least two processors. A Bluetooth chip of the first terminal is mounted on a first processor. The apparatus for sharing the data network is further configured to perform the following operations.

The apparatus for sharing a data network is further configured to perform: transmitting a third data packet satisfied with the second protocol format to the first processor based on a remote procedure call. The third data packet satisfied with the second protocol format is generated by the conversion of the second virtual network card, running by a second processor, based on the preset application-layer protocol. The apparatus for sharing a data network is further configured to perform: sending the third data packet satisfied with the second protocol format to the second terminal through the Bluetooth network.

In an embodiment, operating power consumption of the first processor is lower than the operating power consumption of the second processor.

In an actual application, the first conversion unit 1001, the first sending unit 1002, and the second conversion unit 1003 may be implemented by a processor in the apparatus for sharing the data network. Of course, the processor needs to run a program stored in a memory to implement a function of the above program modules.

It should be noted that the apparatus for sharing the data network, which is provided in the above embodiments as shown in FIG. 10, is only illustrated by the division of the above-mentioned program modules when the apparatus performs the data network sharing. In an actual application, the above-mentioned processing may be assigned to different program modules according to needs, i.e., an internal structure of the apparatus may be divided into different program modules to accomplish all or part of the above-mentioned processing. In addition, the apparatus for sharing the data network provided by the above embodiments belongs to the same idea as the method for sharing the data network embodiments, and its specific implementation process is detailed in the method embodiments, which will not be repeated herein.

Some embodiments of the present disclosure further provide an apparatus for sharing the data network, as shown in FIG. 11, the apparatus includes a first receiving unit 1101, a third conversion unit 1102, and a second sending unit 1103.

The first receiving unit 1101 is configured to receive a first data packet satisfied with a second protocol format and sent by a first terminal through a Bluetooth network, and obtain a second data packet satisfied with a first protocol format and returned by a server based on a first data packet satisfied with the second protocol format. The second data packet is configured to represent a response for the first data packet returned by a corresponding server.

The third conversion unit 1102 is configured to convert the second data packet satisfied with the first protocol format into the second data packet satisfied with the second protocol format based on a preset application-layer protocol.

The second sending unit 1103 is configured to send the second data packet satisfied with the second protocol format to the first terminal through the Bluetooth network. The first protocol format is configured to represent an IP, and the second protocol format is configured to represent a TCP and/or a UDP.

In an embodiment, Bluetooth networks of the first terminal and the second terminal are paired with each other based on a first preset application.

In an embodiment, in response to the first receiving unit 1101 obtaining the second data packet satisfied with the first protocol format and returned by the server based on the first data packet satisfied with the second protocol format, the first receiving unit 1101 is further configured to perform: sending the first data packet satisfied with the second protocol format to a kernel through an intermediate software abstraction layer based on the first preset application; converting the first data packet satisfied with the second protocol format into the first data packet satisfied with the first protocol format based on the preset application-layer protocol; and sending the first data packet satisfied with the first protocol format in the kernel to the server through a physical network card, and receiving the second data packet satisfied with the first protocol format and returned by the server.

In an actual application, the first receiving unit 1101, the third converting unit 1102, and the second sending unit 1103 may be implemented by a processor in the apparatus for sharing the data network. Of course, the processor needs to run a program stored in a memory to implement a function of the above program modules.

It should be noted that the apparatus for sharing the data network, which is provided in the above embodiments as shown in FIG. 11, is only illustrated by the division of the above-mentioned program modules when the apparatus performs the data network sharing. In an actual application, the above-mentioned processing may be assigned to different program modules according to needs, i.e., an internal structure of the apparatus may be divided into different program modules to accomplish all or part of the above-mentioned processing. In addition, the apparatus for sharing the data network provided by the above embodiments belongs to the same idea as the method for sharing the data network embodiments, and its specific implementation process is detailed in the method embodiments, which will not be repeated herein.

In order to implement the method of some embodiments of the present disclosure based on a hardware composition structure of the above-mentioned program module, some embodiments of the present disclosure further provide an electronic device. FIG. 12 is a structural schematic diagram of a hardware composition structure of an electronic device according to an embodiment of the present disclosure. As shown in FIG. 12, the electronic device includes the following components, such as a communication interface 1, a processor 2, a memory 3, a bus system 4, etc.

The communication interface 1 may be capable of interacting with other devices such as a network device.

The processor 2 is connected to the communication interface I to implement information interaction with other devices. The processor 2 is configured to perform the method for sharing a data network provided by one or more of the above technical solutions when running a computer program. The computer program is stored on a memory 3.

In an actual application, each component in the electronic device is coupled to each other through a bus system 4. It may be understood that the bus system 4 is configured to enable connection and communication between components. The bus system 4 includes a data bus, a power source bus, a control bus, and a state signal bus. However, in order to illustrate clearly, various buses are marked as the bus system 4 as shown in FIG. 12.

The memory 3 provided in some embodiments of the present disclosure is configured to store various types of data to support the operation of the electronic device. Examples of the data include any computer program configured to operate on the electronic device.

It is understood that the memory may be a volatile memory or a non-volatile memory. The memory may also include both the volatile memory and the non-volatile memory. The non-volatile memory may be a read only memory (ROM), a programmable read-only memory (PROM), an erasable programmable read-only memory (EPROM), an electrically erasable programmable read-only memory (EEPROM), a ferromagnetic random access memory (FRAM), a flash memory, a magnetic surface memory, a compact disc memory, or a compact disc read only memory (CD-ROM). The magnetic surface memory may be a disk memory or a tape memory. The volatile memory may be a random access memory (RAM), which is used as an external cache. By way of illustration but not limitation, many forms of RAM are available, such as a static random access memory (SRAM), a synchronous static random access memory (SSRAM), a dynamic random access memory (DRAM), a synchronous dynamic random access memory (SDRAM), and a double data rate synchronous dynamic random access memory (DDRSDRAM), an enhanced synchronous dynamic random access memory (ESDRAM), a syn-clink dynamic random access memory (SLDRAM), a direct ram-bus random access memory (DRRAM). The memory provided in some embodiments of the present disclosure is intended to include, but not limited to, the above-mentioned memory and any other suitable type of memory.

The method provided in the above-mentioned embodiments of the present disclosure may be applied to a processor or implemented by a processor. The processor may be an integrated circuit chip with signal processing capability. In an implementation process, each operation of the above method embodiments may be accomplished by the integrated logic circuit of hardware in the processor or instructions in the form of software. The above processor may be a general processor, a DSP, or other programmable logic component, a discrete gate or a transistor logic component, a discrete hardware component, etc. The processor may implement or execute the method, the operation, and a logic block diagram provided in some embodiments of the present disclosure. The general processor may be a microprocessor or any conventional processor. The operation of the method provided in the embodiments of the present disclosure may be directly reflected as being executed by a hardware decoding processor, or as being executed by a combination of hardware and software modules in the decoding processor. The software module may be disposed in a storage medium, and the storage medium is disposed in a memory. The processor reads the program in the memory and accomplishes the operations of the above-mentioned method in combination with a hardware thereof.

When the program is executed by the processor, the processor implements the corresponding process in each of the method embodiments of the present disclosure, which will not be repeated herein.

In the embodiments, some embodiments of the present disclosure further provide a storage medium, i.e., a computer storage medium. In some embodiments, the storage medium may be a computer-readable storage medium, which includes a memory configured to store a computer program. The computer program may be executed by a processor to accomplish the operations described in the above-mentioned method embodiments. The computer-readable storage medium may be memory such as FRAM, ROM, PROM, EPROM, EEPROM, Flash Memory, magnetic surface memory, optical disk, CD-ROM, etc.

In some embodiments of the present disclosure, it should be understood that the disclosed apparatus may be implemented in other ways. For example, the apparatus embodiments described above are merely illustrative. For example, the division of the above units is only a logical function division. In actual implementation, there may be another division manner. For example, multiple units or components may be combined or integrated into another system, or some features can be ignored or not executed. In addition, the mutual coupling or direct coupling or communication connection shown or discussed may be an indirect coupling or communication connection through some interfaces, devices or units, and may be electrical or in other forms

The units described above as separate components may or may not be physically separated, and the components illustrated as units may or may not be physical units. The units may be located in one place, or may be distributed to multiple network units. Some or all of the units may be selected according to actual needs to achieve the purpose of a solution of the embodiments.

In addition, each functional unit in each embodiment of the present disclosure may be integrated into one processing unit, or each unit may exist physically separately. In some embodiments, two or more units may also be integrated into one unit. The above integrated unit may be implemented in the form of a hardware or in the form of a hardware and a software functional module.

Those skilled in the art may understand that all or part of the various methods of the above embodiments may be performed by related hardware instructed by a program. The above-mentioned program may be stored in a computer-readable storage medium. When the program is executed, the operation included in the above method embodiments may be implemented. The above-mentioned storage medium includes: a mobile storage device, a ROM, a RAM, a magnetic disc, an optical disc, and other medium capable of storing program code.

In some embodiments, if the above integrated unit of the present disclosure is realized in the form of software functional module and sold or used as an independent product serve as, it can also be may in a computer readable storage medium. Based on this understanding, the technical solution of some embodiments of the present disclosure in essence or the part that contributes to the related art may be embodied in the form of a software product. The computer software product is stored in a storage medium, including several instructions to enable An electronic device (may be a personal computer, server, or network device, etc.) to execute all or part of the methods described in each embodiment of the present disclosure. The above-mentioned storage medium includes: a mobile storage device, a ROM, a RAM, a magnetic disc, an optical disc, and other medium capable of storing program code.

It should be noted that terms “first”, “second”, etc., are used to distinguish different objects, and are not intended to describe a specific order.

In addition, the technical solutions provided in some embodiments of the present disclosure may be arbitrarily combined without conflict.

The above description is only the specific implementation mode of the present disclosure, but the protection scope of the present disclosure is not limited to this. Any skilled person familiar with the technical field can easily think of changes or replacements within the technical scope disclosed in the embodiments of the present disclosure, and should be covered in the protection scope of the present disclosure. Therefore, the protection scope of the present disclosure shall be subject to the protection scope of the claims.

1. A method for sharing a data network, applicable to a first terminal and comprising:
converting a first data packet satisfied with a first protocol format and sent by a first virtual network card into the first data packet satisfied with a second protocol format based on a preset application-layer protocol;
sending the first data packet satisfied with the second protocol format to a second terminal through a Bluetooth network, and receiving a second data packet satisfied with the second protocol format and returned by the second terminal, wherein the second data packet is configured to represent a response for the first data packet returned by a corresponding server; and
converting the second data packet satisfied with the second protocol format into the second data packet satisfied with the first protocol format, and transmitting the second data packet satisfied with the first protocol format to the first virtual network card, based on the preset application-layer protocol;
wherein the first protocol format is configured to represent an internet protocol (IP), and the second protocol format is configured to represent a transmission control protocol (TCP) and/or a user datagram protocol (UDP).

2. The method according to claim 22, further comprising:
transmitting a third data packet satisfied with the second protocol format to the first processor based on a remote procedure call, wherein the third data packet satisfied with the second protocol format is generated by the conversion of a second virtual network card, running by a second processor, based on the preset application-layer protocol; and
sending the third data packet satisfied with the second protocol format to the second terminal through the Bluetooth network.

3. The method according to claim 2, wherein operating power consumption of the first processor is lower than operating power consumption of the second processor.

4. A method for sharing a data network, applicable to a second terminal and comprising:
receiving a first data packet satisfied with a second protocol format and sent by a first terminal through a Bluetooth network, and obtaining a second data packet satisfied with a first protocol format and returned by a server based on a first data packet satisfied with the second protocol format, wherein the second data packet is configured to represent a response for the first data packet returned by a corresponding server;
converting the second data packet satisfied with the first protocol format into the second data packet satisfied with the second protocol format based on a preset application-layer protocol; and
sending the second data packet satisfied with the second protocol format to the first terminal through the Bluetooth network;
wherein the first protocol format is configured to represent an IP, and the second protocol format is configured to represent a TCP and/or a UDP.

5. The method according to claim 4, wherein Bluetooth networks of the first terminal and the second terminal are paired with each other based on a first preset application.

6. The method according to claim 5, wherein obtaining the second data packet satisfied with the first protocol format and returned by the server based on the first data packet satisfied with the second protocol format, comprises:
sending the first data packet satisfied with the second protocol format to a kernel through an intermediate software abstraction layer based on the first preset application;
converting the first data packet satisfied with the second protocol format into the first data packet satisfied with the first protocol format based on the preset application-layer protocol; and
sending the first data packet satisfied with the first protocol format in the kernel to the server through a physical network card, and receiving the second data packet satisfied with the first protocol format and returned by the server.

7-12. (canceled)

13. An electronic device, comprising a processor and a memory configured to store a computer program capable of being run on the processor;
wherein the processor is configured to, when running the computer program, perform:
converting a first data packet satisfied with a first protocol format and sent by a first virtual network card into the first data packet satisfied with a second protocol format based on a preset application-layer protocol;
sending the first data packet satisfied with the second protocol format to a second terminal through a Bluetooth network, and receiving a second data packet satisfied with the second protocol format and returned by the second terminal, wherein the second data packet is configured to represent a response for the first data packet returned by a corresponding server; and
converting the second data packet satisfied with the second protocol format into the second data packet satisfied with the first protocol format, and transmitting the second data packet satisfied with the first protocol format to the first virtual network card, based on the preset application-layer protocol; or
the processor is configured to, when running the computer program, perform:
receiving a first data packet satisfied with a second protocol format and sent by the first terminal through a Bluetooth network, and obtaining a second data packet satisfied with a first protocol format and returned by a server based on a first data packet satisfied with the second protocol format, wherein the second data packet is configured to represent a response for the first data packet returned by a corresponding server;
converting the second data packet satisfied with the first protocol format into the second data packet satisfied with the second protocol format based on a preset application-laver protocol; and
sending the second data packet satisfied with the second protocol format to the first terminal through the Bluetooth network;
wherein the first protocol format is configured to represent an IP, and the second protocol format is configured to represent a TCP and/or a UDP.

14. The electronic device according to claim 13, wherein the first terminal is configured with at least two processors, a Bluetooth chip of the first terminal is mounted on a first processor, and the processor is further configured to perform:
transmitting a third data packet satisfied with the second protocol format to the first processor based on a remote procedure call, wherein the third data packet satisfied with the second protocol format is generated by the conversion of the second virtual network card, running by a second processor, based on the preset application-layer protocol; and
sending the third data packet satisfied with the second protocol format to the second terminal through the Bluetooth network.

15. The electronic device according to claim 14, wherein operating power consumption of the first processor is lower than the operating power consumption of the second processor.

16. (canceled)

17. The electronic device according to claim 13, wherein Bluetooth networks of the first terminal and the second terminal are paired with each other based on a first preset application.

18. The electronic device according to claim 17, wherein obtaining the second data packet satisfied with the first protocol format and returned by the server based on the first data packet satisfied with the second protocol format, comprises:
sending the first data packet satisfied with the second protocol format to a kernel through an intermediate software abstraction layer based on the first preset application;
converting the first data packet satisfied with the second protocol format into the first data packet satisfied with the first protocol format based on the preset application-layer protocol; and
sending the first data packet satisfied with the first protocol format in the kernel to the server through a physical network card, and receiving the second data packet satisfied with the first protocol format and returned by the server.

19-20. (canceled)

21. The method according to claim 1, wherein the first virtual network card is run by a first processor, data output by the first virtual network card is the first data packet satisfied with the first protocol format, and the method further comprises:
sending the first data packet satisfied with the second protocol format to the second terminal through a Bluetooth connection, after converting the first data packet satisfied with the first protocol format into the first data packet satisfied with the second protocol format through the preset application-layer protocol.

22. The method according to claim 1, wherein the first terminal is configured with at least two processors, and a first processor of the first terminal is responsible for processing the first data packet and the second data packet.

23. The method according to claim 22, wherein in a case where a processor currently running on the first terminal is a second processor, the method further comprises:
converting a third data packet satisfied with the first protocol format and sent by a second virtual network card of the second processor into the third data packet satisfied with the second protocol format, based on the preset application-layer protocol, wherein the third data packet is application data during a process of operating an application.

24. The method according to claim 2, wherein a Bluetooth chip of the first terminal is mounted on a first processor.

25. The method according to claim 1, wherein after transmitting the second data packet satisfied with the first protocol format to the first virtual network card, the method further comprises:
receiving, by the first virtual network card, the second data satisfied with the first protocol format; and
converting the second data satisfied with the first protocol format into the second data satisfied with the second protocol format through a network protocol stack of a kernel, and returning the second data satisfied with the second protocol format to the application layer.

26. The method according to claim 1, wherein the first data packet satisfied with the first protocol format is a data packet transmitted over internet, and the first data packet satisfied with the second protocol format is application layer data.

27. The method according to claim 6, wherein the intermediate software abstraction layer is a socket, and the first data packet satisfied with the second protocol format is obtained by the kernel.

28. The method according to claim 6, wherein the first preset application is installed on the second terminal, and the first preset application is responsible for processing the first data packet satisfied with the second protocol format and received by the second terminal and the second data packet satisfied with the second protocol format.

29. The method according to claim 5, wherein the second data packet is obtained by means of accessing the network through a physical network card of the second terminal.
